(19) United States
(12) Patent Application Publication
(10) Pub. No.: US 2006/0127545 A1
(43) Pub. Date: Jun. 15, 2006

(54) Aseptic production of meat-based foodstuffs

(76) Inventor: Paul Bernard Newman, Devon (GB)

Correspondence Address: STITES & HARBISON PLLC, 1199 NORTH FAIRFAX STREET, SUITE 900, ALEXANDRIA, VA, 22314, US

(21) Appl. No.: 10/525,212

(22) PCT Filed: Aug. 21, 2003
(86) PCT No.: PCT/GB03/03759

§ 371 Date: Nov. 14, 2005

(30) Foreign Application Priority Data
Aug. 21, 2002 (GB) 0219498.3

(51) Int. Cl. A23B 4/20

(52) U.S. Cl. 426/326

(57) ABSTRACT

Meat is processed under conditions preserving its quality and hygiene. Process steps, particularly those in which new meat surfaces are generated, are carried out in an atmosphere comprising CO2 and excluding O2. UV may be used for germicidal action. The meat temperature is preferably kept between O and −2° C. Particularly for red meats, the CO2 content is controlled to maintain a surface pH of 3.5 or less.

### FIELD OF THE INVENTION

The present invention relates to a method of disinfecting or reducing the microbial load of a substrate which may be a foodstuff or food ingredient, especially raw red meat, white meat, and any other suitable foodstuff any individual component thereof and/or any resultant processed product, or the processing environment, any associated equipment and the associated processing. Use may be made of a carrier gas which itself may act as a microbiostat and microbiocide, optionally in the presence of one or more decontaminating agents which themselves may be a gas or a gas in a precursor form, preferably in the presence of a sterilizing atmosphere generated by and maintained by germicidal UV, preferably in the absence of visible light and under tightly controlled temperatures in such a manner as to enhance the overall effectiveness of the method or any other method.

It also relates to methods of simultaneously preventing deterioration of, and/or controlling and maintaining the essential physical, compositional and/or quality attributes of the raw meat or foodstuff and ensuring that the attribute information generated is retained with the finished product. It can also relate to eliminating the need to change the atmosphere in which the final product is stored or packaged or the need to further decontaminate the finished foodstuff after packaging.

### DESCRIPTION OF THE BACKGROUND AND STATE OF THE ART

Several methodologies in the use of Carbon Dioxide and other cryogens to cool foodstuffs are known. For example, U.S. Pat. No. 4,594,253 (Fradin, 1986) describes a method of reducing bacterial growth in poultry carcasses by filling carcasses with CO2 snow before singeing while subsequent mincing, shaping and packaging operations are carried out in a CO2 containing enclosure so as to maintain temperature at 0° C. to −4° C.

U.S. Pat. No. 4,569,204 (AGA 1986) cools a conveyed foodstuff using an evaporating cryogen initially injected into the system as a liquid.

U.S. Pat. No. 4,476,686 (BOC 1984) cools ground meat with CO2 injected as a liquid, moving the meat through the gas by means of rotating screws while U.S. Pat. No. 4,314,451 (BOC 1982) undertakes a similar task using CO2 snow.

However direct contact of raw meat, particularly raw red meat and red meat products, with either solid or liquid CO2 results in freezer burn at the point of contact which is displayed as a loss of colour as well as localized freezing. Also the rate of addition needs to be carefully controlled to maintain the required physical conditions while none of the above detailed methodologies nor other published methods include the provision of eliminating oxygen, air or other undefined gases as included in the present invention to improve performance particularly those related to maintaining meat quality attributes.

Similarly, it is known that Carbon Dioxide can provide a means to induce microbiocidal, and/or microbiostatic properties when foodstuffs and their products are exposed to it in suitable concentrations.

For example, U.S. Pat. No. 5,693,354 (L'Air Liquide, 1997) describes a method of decontaminating fresh vegetables with an aqueous liquid containing significant amounts of dissolved CO2. However it also requires significant amounts of dissolved argon to inhibit bleaching and oxidizing effects of the elevated levels of CO2 required to show decontaminating capabilities.

U.S. Pat. No. 6,066,348 (L'Air Liquide, 2000) replaces dissolved CO2 with a gaseous mixture to disinfect food where the gas mix is preferably nitrogen or CO2 or both as a mix but it may also contain an inert gas. However the germicidal activity of such a mix is low and therefore the mix also contains Ozone, a known and proven powerful germicidal agent in an effective amount. This is all achieved in the absence of shortwave U, a conventional method for generating Ozone U.S. Pat. No. 6,162,477 (L'Air Liquide, 2000) describes the use of ozone containing gas to sanitize, decolorize and deodorize food products which are or have been initially mixed with water. They describe that the required sanitizing effects are enhanced by the use of additional compounds such as hydrogen peroxide, organic acids such as acetic, citric or lactic and possibly stronger inorganic acids such as nitric acid.

However Ozone is a very strong oxidizing agent and in addition to the loss of colour it can also initiate deleterious auto-oxidation reactions in the meat, more particularly red meat which significantly reduce its quality attributes and especially customer appeal. Thus its use on red meat and its products is of extremely limited and while colour loss is not as much of a problem on white meat and fish meat, the fat complement of such meats renders them more susceptible to the generation of deleterious oxidation products more so than that found in most red meats and at a much faster rate.

Methods of decontaminating meat are well known, varied and extensive. A number of comprehensive reviews on the topic are cited in the accompanying references to the present invention and the reader is directed to them for a detailed understanding of the topic. However some examples are quoted here to identify the general mechanisms for decontamination. U.S. Pat. No. 5,460,833 (Minnesota Mining, 1995) reduces microbial load using a combination of fatty acid monoester, acid or chelating agent and a surfactant with water or non-aqueous liquid carrier U.S. Pat. No. 6,183,807 (Ecolab, 2001) uses carboxylic acids and peroxycarboxylic acids mixture to clean and sanitize meat products by spraying at 60° C. at 50 to 500 psi.

European Patent 284 502 (1988) uses ozonated water directly mixed with meat in a rotating screw chamber to effect decontamination while U.S. Pat. No. 6,200,618 (EcoPure, 2001) additionally uses a surfactant with ozone containing wash liquor to decontaminate the surfaces, the surfactant allegedly improving the contact between the decontaminating medium and hydrophobic surface.

U.S. Pat. No. 5,882,916 (Nouveau Technologies, 1999) uses a similar mixture comprising foaming agents and organic acids to remove biofilm and effect biocidal action on contaminated surfaces.

U.S. Pat. No. 6,180,585 (Spartan, 2001) uses a mixture of quaternary ammonium compound, a surfactant and a thickening agent together with Bacillus subtilis to decontaminate and deodorize contaminated surfaces. B. subtilis is known to produce a proteolytic enzyme which digests residual biofilms preventing the formation of unwanted and often foul smelling nitrogenous and sulphurous breakdown products. The thickening agent is presumably to improve the duration of contact of the mixture with the surface to be decontaminated.

Other similar approaches using different decontaminating mixtures include;

U.S. Pat. No. 6,063,425 (Kross, 2000) which disinfects carcasses and meat using sodium chlorite in a weak inorganic (phosphoric) or organic acid (citric, acetic, lactic or similar) while U.S. Pat. No. 4,244,978 (Barta, 1981) which along with others advocates the use of Chlorine Dioxide gas in aqueous solutions. However there have been great concerns about the safety of the chloro derivatives that are formed on contacting foods particularly proteinaceous and its use as such has been severely limited as a consequence. Barta teaches the use of non-toxic concentrations of aqueous solutions of chlorine dioxide to inhibit rather than decontaminate microbial growth.

All of the above use a liquid medium, which may or may not be water, to carry the decontaminating medium to the material. The following examples move away from the reliance of aqueous carriers to contact the material with the decontaminating medium.

U.S. Pat. No. 6,167,709 (BOC, 2001) sprays a mixture of gases (which may include air, carbon dioxide and/or nitrogen), water and ozone on to animal carcasses. The use of the gas mixture not only cools the carcass but also reduces the total amount of fresh water used in processing operations.

U.S. Pat. No. 5,996,155 (Raytheon, 1999) uses sterilizing mechanism utilizing liquid CO2 as a dense phase medium in the presence of UV radiation together with sterilizing agents such as H2O2 or Ozone. However, such a process is totally unsuitable for foodstuffs especially any that require a maintenance of physical condition such as colour, unfrozen condition and changes to flavor profiles; it is further limited by only being able of working in a batch environment.

U.S. Pat. No. 6,036,918 (Enviro Medical, 2000) uses an alternative to the gaseous carrier approach utilizing peracid vapors to sterilize surfaces while using another inert gas to increase the overall pressure in the system and enhance the penetration of the vapors into the load.

U.S. Pat. No. 6,039,991 (Ruozi, 2000) teaches an alternative approach eliminating chemical addition by sanitizing minced meat using a combination of microwave heating and hot air under pressure. Although this lowers the temperature at which sanitation takes place and attempts to maintain total moisture content close to the raw state composition, the principle reactions occur above a temperature at which is known that certain meat muscle proteins denature.

The sources of contamination within a meat processing operation are several-fold. Methodologies detailed above are primarily concerned with the curative approach of reducing the existing microbial load on the foodstuff. Other major potential sources of cross contamination and recontamination are the processing equipment and the processing environment. A number of patents describe methods preventing, or at least reducing the likelihood of this from occurring.

U.S. Pat. No. 4,363,263 (Hester Industries, 1982) describes the use of moist conditions in conjunction with above-atmospheric pressure to prevent processing equipment from becoming contaminated by processed food residues. The system uses a conveying belt for moving food materials through the processing environment and this belt is washed and rinsed continuously outside of the cooker using jet sprays. In the stated embodiments, the approach is primarily directed to cook chill operations rather than the handling of raw materials. In addition, most meat-processing operations work at atmospheric pressures and while washing undoubtedly reduces overall contamination, the application of heat provides the sterilisation step, not available in a meat-processing operation.

U.S. Pat. No. 5,865,293 (New Protectaire, 1999) discloses an air filtration system to prevent product contamination together with a steam cleaner to pre-clean conveyor components such as meat hangers rollers and hooks. The use of a filtered air system attempts to limit contamination of cleaned equipment from airborne sources of contamination. While the cleaning system is suitable for operations where the food conveying mechanism at some exits from the processing environment to allow cleaning to occur, it is impractical where the whole of the processing environment is fully enclosed and exposed to foodstuffs continually.

French Patent 2 744 920 (Marie, 1997) describes a combined method of heating a foodstuff, in this case bread dough, to reduce adhesion, a mechanical method, rotating brushes to remove the dried debris and germicidal UV to resterilize the conveyor. However such an approach is impractical for raw meat as heat denaturation increases rather than reduces its adhesive properties and brushing alone would have minimal effect.

U.S. Pat. No. 6,046,243 (Bernard Technologies, 2000) details a method of creating a surface which uses a non aqueous method of decontaminating materials (not food) comprises a material generating a continuous steady flow of gas capable of generating a microbial growth retardant or decontaminating surface. However the process is not suitable for food as the chemical used in the process are not approved for food use nor is the material capable of adhering to stainless steel surfaces, the usual contact surface for food processing operations.

U.S. Pat. No. 5,597,597 (HolmesNewman, 1996) describes a combined method of decontaminating product and cleaning processing surfaces using germicidal UV within an enclosed chamber yet allowing a continuous process to occur. Finally, all the processes described methods of decontamination of foodstuffs utilising some degree of chemical and/or physical mechanisms that use oxidation and/or denaturation reactions to achieve their main aims. One of the greatest causes of loss of meat quality in raw meat is oxidation reactions. These mechanisms are well described in most classic meat science text books (some of which are quoted here for a more complete reference to the topic). Thus any process which induces oxidation and/or denaturation reactions will be deleterious to the maintenance of meat quality attributes and keeping quality as are processing which add additional moisture to the raw material as a consequence of their activation mechanism, i.e. the use of water to carry the active agents to the site where the action is required.

In such circumstances, methodologies that minimize such reactions as well as limiting them solely to the sites of interest rather than an indiscriminate decontamination action on all materials, i.e. total volume rather than contaminated surfaces alone are to be preferred. The use of germicidal UV is one such mechanism.

There are numerous cited references as to its efficacy and many published patents on its use.

U.S. Pat. No. 5,034,235 (Dunn, 1991) uses pulsed polychromatic light from high energy output sources. However this generates considerable amounts of heat causing product temperatures to rise and inducing varying levels of protein denaturation. It also induces actinic effects in the foodstuffs which in turn generate oxidative reactions and undesirable off-flavors.

U.S. Pat. No. 6,010,727 (Rosenthal, 2000) uses continuous broadband UV but introduces other wavelengths such as UV-B UV-A, visible and near infra-red wavelengths which are claimed to both inactivate enzymes responsible for these actinic reactions and restore damaged organoleptic properties. However such energies permeate deep into the foodstuff and as such are unnecessary for raw meat and similar compounds which only suffer from surface contamination. Such energies also generate large amounts of heat, a component that all raw meat operations need to avoid or minimize to permeate product denaturation.

Actinic reactions primarily occur in foodstuffs and products exposed to high oxidative energies found in medium and high power broad spectrum UV sources coupled with high water activities and low acidic pH. Examples of foods of this type are winter pineapple, fruit juices and milk. While fresh meat under normal atmospheric conditions has a aW of up to 0.99, frozen meat or meat with a dried surface have much lower aW. Also the pH of raw beef is usually in the range pH5.6-6.0 with other meats showing a similar range. As such it is possible to use other methods to reduce the level of oxidation reactions within or upon the product and prevent or minimize the formation of breakdown products that would affect meat quality and keeping quality attributes.

Thus the primary source of loss of meat quality and keeping quality is oxygen and by-products generated by oxidative reactions. Controlled atmosphere packaging (CAP) and modified atmosphere packaging (MAP) are well known methods of food preservation and their use is well established in the sphere of food packaging.

U.S. Pat. No. 5,948,457 (Tenneco, 1999) is quoted as illustration. Typical methodologies are outlined within it while it also lists a very extensive reference section detailing other examples of the art. It also details the alleged advantages of low oxygen or no oxygen gas mixtures for preserving meat quality attributes. However the typical volumes of gases found in such packages exert there preserving action by modifying the atmosphere within the package thus exerting an effect on the growth potential of the residual microorganisms not through any substantive decontamination effect nor by significantly modifying any of the physical properties of the meat.

Therefore a need exists to better control the meat processing environment and the materials being processed within it so as to more effectively reduce or remove the microbial population on the materials being processed, eliminate sources of cross contamination and recontamination within that environment and simultaneously maintain or improve the meat quality and keeping quality attributes of the products processed and produced within that system.

### SUMMARY OF THE INVENTION

Preferred embodiments of the present invention may enable one to achieve one or more of the following:

(i) to reduce or obviate the drawbacks of using decontamination methods for meat which may rely entirely or in part, on chemical methods;

(ii) to reduce or obviate the limitations of decontamination methods for meat which principally rely on adding powders, water, solutions or other liquids to raw meat and its subsequent products such that either the volume of water added may either exceed the natural proportions normally found in raw meat and its products and/or may require labelling of the fact, accordingly;

(iii) to provide a method that can enhance the decontamination capabilities of the system by changing the physical properties of the meat to make the surfaces of both the raw foodstuff materials, their intermediate and finished products less suitable for microbial growth and the microbes themselves more susceptible to the decontamination treatment and as a consequence enhance the keeping qualities of the raw meat and its products so formed. These objects can be provided by pre-grinding (if necessary) the meat to a substantially uniform size and exposing the freshly ground meat particle surfaces to a sufficient quantity of carbon dioxide gas such that the pH at the surface of the meat is reduced to pH 3.5 or less and a suitable narrow wavelength, germicidal UV source. Additionally and if necessary, provision is made to add a further decontaminating component to the gas flow which may be any suitable substance such as reduced quantities of any suitable salt solution, liquid or powder or Chlorine Dioxide or an inactive precursor to such a gas which becomes active on contacting the carbon dioxide enriched surface of the ground meat;

(iv) to minimize sources of recontamination and cross contamination within the processing environment generated or enhanced by either the decontamination actions upon the processing equipment itself or the enclosed atmosphere within which the processing operations occur, or a combination of both;

(v) a method which utilizes mechanical or physical or chemical actions within the processing operation to keep the processing equipment as physically clean and debris free as practically possible and substantially continually present all exposed surfaces to a suitable physical decontaminant such as UV-C on its own or in conjunction with reduced quantities of solutions, liquids, powders or carbon dioxide gas that may contain an effective quantity of decontaminating agent or agents in active or precursor form such as chlorine gas, chlorine dioxide or sodium chlorite, with or without the additional use of surfactants, wetters or spreaders. The processing atmosphere can be maintained aseptic by any suitable method using any suitable substances which may include a combination of the mechanism of forming the carbon dioxide, passing the carbon dioxide though suitable physical filters and then exposing the suitably filtered gas to a suitable germicidal UV source before entering the processing environment;

(vi) to minimize oxidation reactions or the rate of oxidation reaction occurring within the product and thus maintain the highest meat quality attributes or even enhance the meat quality.

A preferred type of embodiment is a method which preferably undertakes, all material grinding operations, material measurement operations, or at least as many as practical, material adjustment and blending operations in a totally enclosed environment of Carbon Dioxide or Carbon Dioxide with other gases or substances to the substantially complete exclusion of Oxygen (as far as is feasibly practical in a high volume continuous manufacturing operation) and may include the provision of a suitable means to monitor and maintain the substantially complete exclusion of oxygen without the need for any evacuation step nor a need to significantly alter the atmospheric pressure within the processing environment while excluding substantially any presence of natural or artificially generated light of any wavelength except that which may be generated by the narrow wavelength UV sources used to generate a substantially aseptic atmosphere within the substantially enclosed processing environment. This method can be further enhanced by accurately monitoring and controlling the processing temperature to ensure it substantially remains in the range −2° C. to 0° C. without causing freezing of the meat or foodstuff or if processing operations cause deviation from the desired range, it returns, through either active or passive interventions, to the set temperature as quickly as possible thereafter.

### DETAILED DESCRIPTION OF THE PREFERRED EMBODIMENTS

At a time when there is increasing consumer demand for natural, if possible organic, foods and an increasing regulatory requirement for reduction or elimination of artificial chemicals and preservatives in such foods, particularly meat and meat products, it is alarming to note that many proposed methods for decontaminating meat and other foodstuffs rely on the addition of chemicals not normally found in or on such foodstuffs or by irradiating such foodstuffs with ionising radiation.

In accordance with one aspect of this invention, it has been found that exposing meat surfaces to an introduced atmosphere predominantly of gaseous Carbon Dioxide during all practical stages of processing has resulted in a significant reduction in the total numbers of viable microorganisms compared with meat not so treated. For the purpose of definition, the Carbon Dioxide atmosphere means an atmosphere which is predominantly Carbon Dioxide but may also contain amounts of other gaseous including Nitrogen and noble gases such as Argon, Krypton, Xenon and Helium but excluding Oxygen. It may also include additional gaseous components. For the purpose of definition the term ‘additional gaseous components’ may include but is not limited to Chlorine, Chlorine Dioxide or Ozone. However the composition of the Carbon Dioxide in the total introduced atmosphere will always exceed the combined total of the other gaseous components by at least a ratio of 2:1 and preferably 4:1 or more. In a preferred embodiment, the atmosphere is exclusively or virtually exclusively Carbon Dioxide with or without any additional gaseous components added in a concentration sufficient to induce a synergistic microbiocidal effect.

This effect is further enhanced by the various stages in the processing operations including but not limited to the grinding, cutting, blending and agitation processes all of which ensure that all new surfaces formed are thoroughly bathed in the Carbon Dioxide atmosphere. The operations generating the new surfaces cause an increase in the free natural moisture on the surface of the particles, primarily due to cellular disruption and diffusion which further enhances the ability of the surface to absorb further amounts of Carbon Dioxide resulting in increasing acidity at the immediate surface. While the microbiocidal effect is noticeable at pH values below 4.0, in a preferred embodiment of this aspect of the invention, the effect is maximised when the level of dissolved Carbon Dioxide is such that the pH at the immediate surface of the particle is 3.5 or less.

It is a further aspect of this invention that the effect is still further enhanced when the temperature of the surface of the meat is kept substantially at 0° C. or below but not lower than −2° C. such that any part of the foodstuff being processed is exposed to any substantial freezing or freeze followed by thawing. This is effectively accomplished by either using the Carbon Dioxide atmosphere in a form which provides substantial latent heat to the operation such as a pressurised liquid or as a solid such that it additionally acts as a refrigerant during the subsequent processing operations, or by the use of any suitably refrigerated, filtered and sterile gas to act as the refrigerant. The gas may also contain as much Carbon Dioxide as is necessary to maintain the pH at the surface of the foodstuff at the optimum desired pH.

By introducing the Carbon Dioxide atmosphere to the processing system in this manner and further allowing it to contact all food surfaces immediately they are formed throughout the many processing operations, it eliminates the need to previously dissolve the gas in any liquid or other carrier prior to or during any contact step.

Many chemical methods which rely on, if not entirely, at least in part, the lowering of pH as a means of generating antimicrobial properties, also require the presence of carrier liquids not only to provide suitable dilutions thus preventing the introduction of deleterious physical and chemical properties to the foodstuff being treated, but also to effect an even distribution around the particle surfaces. The use of Carbon Dioxide atmosphere as described here is both advantageous and desirable as it eliminates all of these deleterious effects without the addition of any significant amount of carrier liquid or other medium.

In a further aspect of this invention it has been found that with the surfaces of the meat, meat product or other foodstuff substantially exposed to the Carbon Dioxide atmosphere, the addition of other natural products or materials can synergistically enhance the overall microbiocidal and microbiostatic effects of the Carbon Dioxide atmosphere alone.

In a preferred embodiment to the invention, the various stages in the processing operations including but not limited to the grinding, cutting, blending and agitation processes are not only exposed to sufficient of the Carbon Dioxide atmosphere to achieve the pH conditions required and an excess of the gas to maintain them throughout but they are simultaneously exposed to a suitable source of narrow wavelength of germicidal UV. This exposure may be in the form of one continuous exposure throughout the processing operation or several discontinuous exposures of differing doses and durations throughout the processing operations such that a synergistic effect between the Carbon Dioxide atmosphere and the germicidal UV is achieved resulting in a substantially greater anti-microbial effect that can be achieved with either the same level of the Carbon Dioxide atmosphere or germicidal UV alone.

These specific conditions produce a very substantial microbiocidal reduction in both pathogenic bacteria and total viable counts for a very wide variety of foodstuffs. However, very occasionally, either when the foodstuff has a very heavy total microbial load or contains some very specific pathogens, a more extensive decontamination treatment has been necessary to ensure a satisfactory reduction for processing purposes. In such circumstances, it has been necessary to add additional materials to achieve this.

It is therefore a further embodiment to this invention that these additional materials which may include but not limited to chlorine gas, chlorine dioxide gas, ozone, all in gaseous form or organic acids such as citric, acetic or proprionic or sodium chlorite in micro-droplet solution form or any other suitable decontaminating component, can be introduced to the Carbon Dioxide atmosphere gas stream which acts as a carrier to these materials and moves them to the surface of the foodstuff. These additional decontaminating agents are applied at a concentration that would achieve the necessary level of decontamination without exceeding any regulatory limitations on the upper level of concentration used, or upper levels of residual concentration remaining in or on the foodstuff after treatment, or failing to meet and statutory labelling requirement.

As prolonged exposure to elevated levels of the Carbon Dioxide atmosphere and germicidal UV and any additional decontaminating agent can be hazardous to the health of human operatives working within the processing environment, it is a further embodiment to the invention that these reactions and interactions occur within a substantially enclosed processing environment which minimises any human exposure to either or both processes.

While one of the principle aims of these inventions is to substantially decontaminate the surfaces of foodstuffs prior to commencement of processing operations. it is acknowledged that such action does not generally sterilise the foodstuff. As a consequence without suitable preventative treatment all the surfaces of the processing operation equipment which come in contact with the foodstuff would steadily become contaminated themselves and act as a potential source for cross contamination and recontamination of already substantially decontaminated foodstuffs.

It is therefore a further embodiment of this invention that most, if not all, of the processing equipment which comes in contact with the foodstuff being processed is itself subjected to a decontamination regime similar to that of the foodstuff. This may be the Carbon Dioxide atmosphere alone, the germicidal UV alone, or the Carbon Dioxide atmosphere together with the germicidal UV, or any of these in combination with but not limited to chlorine, chlorine dioxide, ozone all in gaseous form or organic acids such as citric, acetic or proprionic or sodium chlorite in micro-droplet solution form or any other suitable decontaminating component at a concentration that would achieve the necessary level of decontamination without exceeding any regulatory limitations on the upper level of concentration used, or upper levels of residual concentration remaining in or on the foodstuff after treatment, or failing to meet and statutory labelling requirement as the result of any such treatment.

To achieve the required level of continuous sanitation of processing equipment; the surfaces of such equipment need to be substantially devoid of physical debris and/or biofilm residue. While this is usually accomplished by the continuous movement of the foodstuff components through the processing equipment or the mechanical action of the processing equipment or the interaction between the physical surfaces of the equipment and the foodstuff components, occasionally there is a need to augment such activities to achieve the required low level of residual physical debris and/or biofilm residue.

It is therefore a further embodiment of this invention that mechanical and/or other physical attributes can be applied to the processing system equipment components as necessary. This may be in the form of scrapers, brushes, air jets, water jets or similar actions where the surface to be cleaned has occasion to be presented to the mechanical cleaning action without the presence of the foodstuff or where otherwise allowable.

Alternatively this may be achieved by one or more of the foodstuff components themselves in either an isolated form, for example, rusk, bran or other abrasive foodstuff used in a sausage or product formulation or a changed physical state for example lean meat in a substantially frozen or tempered state. These may be within a substantially continuous processing operation or between phases of a substantially continuous processing operation or in a discontinuous batch processing operation. Additionally the application of such augmentation can be through manually intervention or automatically through the use of suitable sensors that detect the changing state of the residual level of physical debris and/or biofilm residue.

It has already been stated in a previous embodiment to this invention that the Carbon Dioxide atmosphere is supplied in an excess of that necessary to achieve the desired level of microbiocidal and microbiostatic control. Such a waste of excess material is an additional expense to operational costs. In an effort to eliminate such additional processing cost a further embodiment to this invention, allows for the excess Carbon Dioxide within the Carbon Dioxide atmosphere to be recovered and reused. This is substantially achieved by venting the excess gas from the processing system and passing the excess gas back into the gas generation system through a series of necessary filters to remove unwanted gases and contaminating materials for example an oxygen absorber to remove unwanted oxygen, an oxygen scavenger to remove unwanted residual oxygen, a scrubber unit to remove unwanted moisture and materials in solution or suspension, a filter to remove particulate matter and a germicidal UV cabinet to remove contaminating microbial organisms. Other units can be added to remove any other specific unwanted materials as necessary. The cleaned Carbon Dioxide atmosphere can then be reprocessed, for example, put under pressure to change the Carbon Dioxide component of the Carbon Dioxide atmosphere to a liquid or otherwise refrigerated to convert it back to a solid form or merely recycled directly in gaseous form at a suitable temperature. Such a final step would also allow any of other gaseous contaminants not already removed or inert to other applied removal steps to be removed from the recovered gas.

Additionally, and as a further embodiment, this also serves as a method of maintaining the processing atmosphere substantially aseptic.

Such an approach can also be applied with modification to achieve another stated aim of the invention. In a further embodiment to the invention, the introduction of an excess of the Carbon Dioxide atmosphere to the processing operation at its very earliest stages allows for all subsequent processing operations to be carried out in an atmosphere which minimises or preferably eliminates the presence of air, and more specifically, oxygen. All oxidation reactions are substantially deleterious to a number of attributes related to product quality. For example, meat in the presence of air or oxygen will irreversibly change colour from an initially attractive red colour primarily due to the formation of oxymyoglobin to an unattractive brown colour primarily due to the formation of metmyoglobin. In the presence of the Carbon Dioxide atmosphere and the absence of air or oxygen, an alternative purple red pigment, ferrous myoglobin is formed and is maintained in the continued absence of of air or oxygen. However, the attractive Oxymyoglobin is easily reformed when the meat is re-exposed to air in a controlled manner, for example, within a modified atmosphere package.

A further advantage of the presence of the Carbon Dioxide atmosphere and the absence of air or oxygen is the minimising or elimination of deleterious biochemical and chemical reactions within the foodstuffs which result in a reduced keeping quality of the foodstuff, an increased likelihood of the generation of off-flavours and off-aromas due to the formation of oxidation products and the generation of an atmosphere more favourable to the growth of any residual aerobic microorganisms which themselves generate different but additional off-flavour and off-aromas.

In a further preferred embodiment to this invention, all processing steps which include the presence of germicidal UV are carried out in an atmosphere substantially of Carbon Dioxide and to the exclusion of oxygen or air. Germicidal UV is a known oxidiser and under specific conditions particularly in the presence of foodstuffs which are low pH and/or contain components capable of substantial oxidation such as unsaturated fats, germicidal UV can initiate undesirable accelerated actinic oxidation reactions. The presence of a substantially air or oxygen free atmosphere will minimise or eliminate these effects. However, while nitrogen or other inert gases can achieve such an atmosphere, and would permit germicidal UV to have a decontaminating effect on its own, they do not allow the immediate surface of the meat or other foodstuffs to become sufficiently low in pH to enable the synergistic microbial reduction reaction to occur as when germicidal UV and Carbon Dioxide are simultaneously present.

In a further preferred embodiment to this invention, all or most of the processing operations are undertaken in an environment also substantially devoid of natural or artificial light except for that generated by germicidal UV or as a consequence of the generation of germicidal UV. Light or more particularly reactions such as photo-oxidation or photo-degradation which reduce overall meat or food quality are initiated, amplified and/or accelerated by the presence of natural light and certain wavelengths of artificial light. Germicidal UV alone does not generate such an oxidising environment.

It is a further aspect of this invention that the effect is still further enhanced when the temperature of the surface of the meat or other foodstuff is kept substantially at 0° C. or below but not lower than −2° C. such that any part of the foodstuff being processed is exposed to any substantial freezing or freeze followed by thawing.

The early provision of a controlled and defined aseptic processing environment also allows for that aseptic atmosphere to be maintained throughout all processing operations. It also permits the aseptic atmosphere to be continuously or subsequently modified so that the product is substantially in its final defined and desired atmosphere at the time it enters its packaging operation. This has a double benefit. Firstly the aseptic nature prevents any product recontamination or cross-contamination as the product moves between processing and packaging operations thus maintaining the very highest level of product safety. Secondly, it eliminates the need for the customary evacuation cycle at the time of final packaging when the existing atmosphere is removed and replaced by a defined atmosphere within which the product is sealed during any final packaging operation.

It is a further embodiment to this patent that the essentially Carbon Dioxide atmosphere in which the product substantially undergoes its processing operations is monitored and controlled or monitored and adjusted, either in a single step or in a series of smaller controlled steps so that the finished or final product is predominantly surrounded within the desired final packaging atmosphere at some suitable point during the processing operation and certainly before it enters any final packaging operation.

### BRIEF DESCRIPTION OF DRAWING

The sole FIGURE is a schematic view of apparatus for carrying out a process embodying the invention.

### DESCRIPTION OF EMBODIMENTS

### EXAMPLE 1

Production of Formed and Filled Chicken Patties using Frozen and/or Chilled Meat

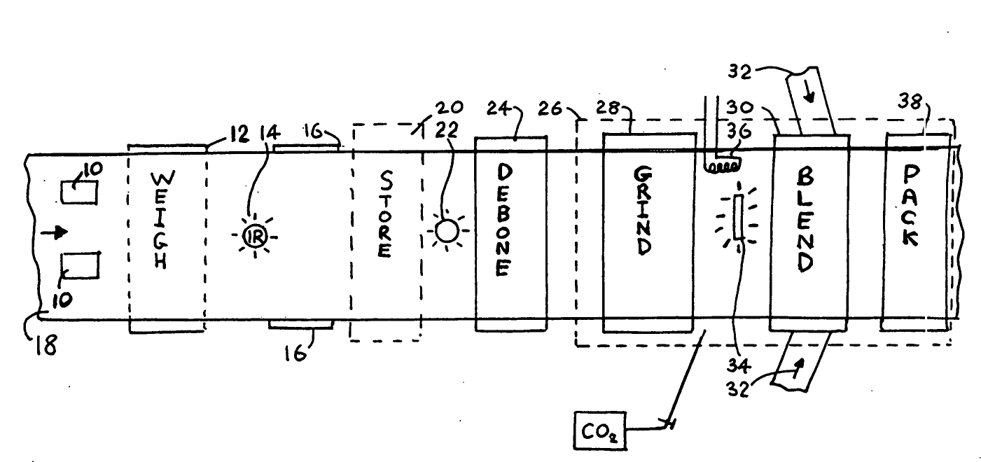

The apparatus is shown, highly schematically, in FIG. 1.

Frozen chicken meat of 3 different types, breast meat with less than 5% fat; breast trim with less than 15% fat and chicken skin with less than 35% fat is initially sorted into fat content groups within each of the 3 major fat content groups from either pre-production QA measurements and/or reference to an internal supplier database detailing specific supplier composition performance.

The blocks of chicken meat 10 are removed from their boxes and weighed (at a weighing station 12). Optionally if necessary after manual inspection, the blocks are passed through a heater module, preferably an impingement source of heat, preferably IR lamps 14. The duration of dwell under the lamps is determined by lamp intensity and incoming product temperature so that only the immediate surfaces are raised to a temperature just above freezing point. This will allow any residual spin chill water (an undesirable residual from the manufacturing process) to thaw and drain from the product. (Collecting troughs 16 are shown at the sides of the conveyor 8). The blocks are reweighed on exiting the heater module.

If necessary, for example they are not required immediately for processing, the blocks are allowed to refreeze, stacked in rows where each block is separated from each other by a non-stick covering such as polythene sheeting and the whole stack is covered in a protective non-stick cover of suitable material.

When required and if necessary, the blocks are removed from the store 20 and passed through an energy source such that the frozen or tempered blocks rises evenly to a temperature above freezing such that all the meat is thawed. Preferably the final equilibrated temperature should be between −2° C. and 0° C. and the energy source 22 is preferably microwave or Rf.

When available, use of fresh chilled meat in place of frozen and thawed meat, is a preferred option. This meat should also enter into the processing system between −2° C. and 0° C. If cooling is necessary to achieve this temperature range, it is substantially achieved using one or more of the preferred embodiments previously described.

It is well known that trim meat has a much higher content and occurrence of bone and bone fragments than whole muscle and for safety reasons it is preferable to pass the meat through a detection and removal system 24 so that all such bone can be automatically detected and removed from the meat prior to processing. This can be achieved by a number of different methods but preferably in a manner as detailed in patent GB2315584. This is usually be done without any need to further reduce the size of the material at this time as the thawed trim and breast meat is of a size suitable for passage through the detection system. However if larger material is used, for example whole muscle turkey meat, provision is made to reduce the meat size to that of 7.5 cm or less by passage through a conventional meat pre-grinder or any other suitable method. However the larger the pieces of meat and the less the cutting of the material, the better the level of detection as it reduces the likelihood of further breaking of bone. Such a method also allows for the detection and rejection of other contaminants in the meat and their immediate rejection.

It may also be necessary to fine tune the product formulation based on its moisture, fat and protein content separately and together. Using the methodology and apparatus detailed in patent GB2315584, fat measurement can be undertaken simultaneously within the same apparatus. Where such continuous measurement apparatus is not available, alternative batch techniques can be used. Moisture measurements are similarly be undertaken simultaneously within the constrained meat flow by various established methodologies such as electrical conductance or Infra Red reflectance. This can be directly in the flow of the meat anywhere along its constrained flow or preferably as it passes into or out of the fat measurement system. If such continuous measurement apparatus is not available, alternative manual techniques can be used.

With two such measurements, in a material such as boneless chicken meat and in the absence of any additional components, protein can be determined by difference, i.e. adding the measured total fat and total moisture content together and deducting that from the total weight of meat analysed. Once the meat has been measured and providing it is within the acceptable temperature range, it now enters the aseptic, or essentially aseptic, part of the system 26. The meat is passed through a grinder 28 where it is reduced to its final desired particle size. If required it may be simultaneously desinewed. The particles exit the grinder and then pass either directly to a blender/mixer 30 (where they may be mixed with one or more further product streams 32) or into intermediate storage containers.

As the meat passes to these containers or the blender (or earlier if already of acceptable particle size) it passes along an enclosed conveying mechanism which contains controlled wavelength UV-C light around most or all of its surface such that all the meat passing along it is exposed to the UV-C light, the duration of which is sufficient to achieve a reduction of total microbial organisms and an elimination of all microorganisms considered to be pathogenic, for example, E. coli, Salmonella, Listeria and Campylobacter. However the sources 34 of UV-C used do not generate any significant heat thus preventing the denaturing the particle surfaces.

The conveying mechanism is so constructed to ensure all external particles surfaces are evenly exposed, this can be for example by means of a rotating screw feed, the tumbling motion of a conveyor bed with frequent changes in height and continuity, through gravity by falling from one conveying surface to another. Alternatively it can be a combination of more than one conveying motion.

The effectiveness of the microbial inactivation may be sufficiently achieved through the exposure to UV-C. However it has been shown that the effect can be significantly improved by exposing the particles to acidification, i.e. lowering the pH normally found in such meat, i.e. 5.5-5.9. The use of water or other solutions is undesirable as the increase in wetness at the particle surface reduces the effectiveness of the UV treatment alone. Acidifying gases such as oxides of chlorine or oxides of nitrogen or oxides of sulphur are effective. However many of these are difficult to work with and control in a processing environment because of the inherent danger they pose to humans and the undesirable physical or chemical effects they cause to the meat itself. A practical and suitable alternative is Carbon Dioxide.

Excess of the gas is exposed to the meat immediately prior to, during and immediately after exposure to the UV-C. The amount of gas present is automatically controlled so that an excess is always present. The length of exposure both before and after the UV-C treatment may be such that it commences before the meat enters the measurement system and continues to some suitable point in the operation after holding and/or blending as the maintenance of the low pH of the particle surfaces acts as a further prevention against recontamination. In addition, the presence of a high water activity and free moisture means that further gas will readily dissolve in this moisture and maintain the surfaces of the processing equipment in an effectively aseptic condition due to their acidic nature and the UV-C exposed carbon dioxide atmosphere is also effectively aseptic itself.

The meat from the different sources is then mixed together in the desired proportions. This may be in continuous but regulated streams simultaneously unloading into a mixer/blender or screw conveyor or tumbler with continuous motion. Alternatively it may be in a consecutive manner where the second component, usually the second largest component by weight or volume, is added to the first stream which is the principle component or the largest component by weight or volume, and is subjected to blending in a continuous or batch method. Ideally this is an intermediate mixer or screw conveyor or series of screw conveyors or tumbler in which the components are added and moved in an appropriate motion to achieve the desired evenness of blend. This approach can be repeated for a third or subsequent components either in the same mixer or a different mixer or screw conveyor or tumbler further along the processing operation.

Additional components which enhance physical attributes of the final product such as water holding or water binding capacity should be added in a form which ensures an even distribution when all the meat components have been added and blended. This may be in a sprinkled or shaken method and then the meat reblended. Alternatively and preferably, it is in a mist spray in which these additive components have been thoroughly dissolved and/or dispersed with the water used for such purposes can also be used as make up water, i.e. ensure the final formulation has the correct total water content. This additional moisture will encourage further Carbon Dioxide to dissolve and maintain its acidic state on the surface of the particles. Alternatively, the volume, concentration, temperature and pH of the dissolved additional components is selected and controlled such that the mixed meats achieve an even optimal pH and temperature during this mixing period.

It is preferable that such operations occurring after the measurement of the fat and/or moisture components should be done in the controlled enclosed environment in the presence of Carbon Dioxide or UV-C or more preferably, a combination of both as previously detailed in the embodiments of this invention, to the extent that the surfaces of the meat particles are microbially decontaminated and maintained as such for as long as possible.

The apparatus in which the whole operation takes place is additionally maintained in an aseptic state by the provision of a continuous cleaning and sterilisation regime similar to that described in part in U.S. Pat. No. 5,597,597 and/or U.S. Pat. No. 6,165,526 and/or U.S. Pat. No. 6,349,526 and/or PCT Patent Application WO 01/11993. The method or combination of methods used will be dependent upon the configuration and requirements of the processing system, the ingredients used and the product formed.

Additionally and wherever possible natural daylight, InfraRed light and UV-A and UV-B wavelengths of Ultraviolet light are excluded from the system as these have been shown in chicken patty production to reduce product quality by increasing the rate of product oxidation and raise product temperature.

Additionally, the temperature of the processing system and the product within it are maintained as close to −2° C. to 0° C. as possible either by the application of refrigeration 36 where necessary, or by using refrigerated gases in the atmosphere. However, the temperature must not be allowed to fall to the extent that ice crystals reform in any of the single or mixed components or rise so that product quality is affected.

Once mixed to the correct composition and consistency, the product is allowed to progress to the forming lines where the patties are formed, filled and finished as necessary. Alternatively it can be held in a refrigerated, preferably aseptic state until required.

Finally, after all processing has been completed, the finished product is packaged in a similarly aseptic manner 38, for example as detailed in U.S. Pat. No. 6,349,526.

### EXAMPLE 2

Production of Ground Meats from Fresh Meats

This type of product follows a very similar handling and processing regime as the frozen or frozen/fresh product of Example 1 but with a number of modifications.

With fresh meats there is no need to remove spin chill water or to thaw the product prior to use. However there is a need to minimise product oxidation as early as possible and if the meat has pigmentation there is a desire to retain the bright red colour.

Meat can enter the system either direct from a boning line or indirectly from cartons, combos or packages. Because of its potential to become contaminated quickly as such trims often originate from the outside surfaces of carcases which have been exposed to contamination for periods ranging from hours to a few days, there is a need to decontaminate at a very early stage in the processing operation.

Fresh meat from boning lines will likely be subjected to evaporation and drying and thus the surfaces will be dry. Meat stored in combos, cartons and packages is likely to be very wet on the surface due to the pressure exerted during packaging and/or storage. It is therefore essential to redistribute the extraneous meat juices/moisture to get as dry a surface as possible before any decontamination step to improve overall system decontamination efficiency. The meat is therefore passed through a pre-grinder or pumped to expose many new surfaces as possible and mixed and/or tumbled to allow the purge or drip previously formed to be dispersed and absorbed on to these new surfaces and make the product external surfaces less wet. It also reduces the size variation of the different components, thus improving the flow and handling characteristics throughout the whole processing operation.

Immediately after the pre-grind, pumping, or mixing the product is evenly dispersed and exposed to UV-C in a manner described in example 1 so as to achieve the desired level of decontamination. Similarly, as far as can be practically achieved, all equipment contact surfaces should be similarly continuously or sequentially decontaminated.

The same synergism can also be achieved with the additional use of a modified atmosphere such as Carbon Dioxide.

However, unlike poultry meat which has no pigment, red meat exposed to excessive Carbon Dioxide is likely to form an unattractive brown pigment. Therefore it is important to ensure there is sufficient Carbon Dioxide to cause acidification of the meat surfaces but not an excess so as to cause the formation of the brown pigment. Thus instead of maintaining a 100% CO2 atmosphere throughout the controlled element of the processing operation, the atmosphere can remain at 100% prior to the pre-grind and then it is progressively reduced to 20%-40% of the total (or whatever the modified atmosphere of the final package is going to be) once the product undergoes its final grind. The balance of the atmosphere is made up from any mixture of inert gases as previously described but in all cases, oxygen should be omitted, or if required as part of the final package atmosphere, at least until just before or during final packaging.

Ingredient mixing, final formulation and ingredient blending is accomplished by whatever batch or continuous method is most suitable, but preferably as detailed in example 1.

### EXAMPLE 3

Production of Fresh and Cooked Sausage

This is essentially a combination of the most important elements of examples 1 and 2 with additional provisions for microbial control after processing operations are completed. Meat handling, formulation control and decontamination for fresh red meat sausage is essentially that as detailed in example 1 for chicken patty production but with the provisos detailed in example 2 particularly those relating to red meat colour and oxidation.

Cooked sausage follows similar processing and handling details to fresh sausage except that the retention of the fresh red colour is not essential and thus higher levels of CO2 can be maintained for the whole processing operation up to and including its stuffing into sausage casings.

Cooked sausage, once cooked, is either packaged skin-on i.e. the casing remains intact and the cooked product is merely packaged, or skinless, in which case the casing is removed and the now firm sausage is then packaged.

In either case the sausage is sterile at the time it exits from the cooker. However handling and packaging steps can cross contaminate or recontaminate the product. This is minimised or eliminated by exposing the conveying and handling equipment along which it passes and the final packaging material to the same UV-C exposure as the materials and equipment as detailed in examples 1 and 2. If required, and as an additional protection, the cooked sausage can also be similarly re-exposed. There is no need to eliminate light or oxygen as the product is stabilised by the cooking process.

While the refrigeration requirements are also less rigid, it has been shown that subjecting cooked sausage of any form to a chilled refrigeration step (ideally again to reduce the product temperature to between 0° and −2° C.) at any suitable time and production location between the end of cooking and any time up until immediately after packaging, has a synergistic effect on the reduction of microbial numbers.

Where the casing is removed, the skin-on sausage is exposed to UV-C to resterilise its surface prior to skin removal, the duration and intensity of the exposure being sufficient to reach the desired decontamination level within the time and production constraints imposed. The skin removal apparatus including the knife is similarly treated as are all food/processing equipment contact surfaces.

All of the above examples can be equally adapted either singly or in combination to handle and process non-meat based foodstuffs.

1) A method of treating meat comprising a meat treatment step in which new meat surfaces are generated, characterized in that said step is carried out in an atmosphere comprising CO2 and substantially free from O₂.

2) A method according to claim 1 in which the atmosphere is provided by gas which has been sterilized by UV irradiation.

3) A method according to claim 1 or claim 2 wherein the meat is maintained in the temperature range −2 to 0° C.

4) A method according to any preceding claim wherein the carbon dioxide concentration is selected so that the meat surfaces have pH values of 3.5 or less.

5) A method according to any preceding claim including a plurality of meat treatment steps in at least one of which new meat surfaces are generated, all of said steps being carried out in said atmosphere.

6) A method according to any preceding claim including a step of decontaminating processing equipment that comes into contact with said meat by treatment with said atmosphere and/or by UV irradiation.

7) A method according to any preceding claim wherein the meat is processed in the substantial absence of light.

8) Apparatus for carrying out a method according to any preceding a claim comprising a treatment chamber containing means for generating new meat surfaces, and a source of CO2 coupled to the chamber.
